(19) United States
(12) Patent Application Publication
(10) Pub. No.: US 2021/0163806 A1
(43) Pub. Date: Jun. 3, 2021

(54) AQUEOUS SOLUTION WITH DEPRESSED FREEZING POINT

(71) Applicant: FROSTY COLD, LLC, Overland Park, KS (US)

(72) Inventors: JOHN R. BERGIDA, WILDWOOD, MO (US); DAVID D. LEAVITT, EDMOND, OK (US)

(21) Appl. No.: 17/106,751

(22) Filed: Nov. 30, 2020

Related U.S. Application Data
(60) Provisional application No. 62/942,010, filed on Nov. 29, 2019.

(51) Int. Cl. C09K 5/20

(52) U.S. Cl. CPC C09K 5/20

(57) ABSTRACT

A method of using a thermal hysteresis agent (THA) or antifreeze agent in a water solution that binds to ice crystals to inhibit growth and recrystallization of ice. The THA or AFA is selected from the group consisting of insect, fish, plant, and genetically modified THAs/AFAs wherein a concentration of THAs/AFAs in water of 5 mg/mL depresses the freezing temperature in the range of about 3.4 to 4° C.

### CROSS REFERENCE TO RELATED APPLICATIONS

This application claims priority to U.S. application Ser. No. 62/942,010 filed on Nov. 29, 2019, the disclosure of which is incorporated by reference herein in its entirety.

### TECHNICAL FIELD

This disclosure is directed to an aqueous solution with antifreeze agents that achieve the same level of freeze protection as current commercial antifreeze/heat transfer products but with greatly reduced concentrations of constituents that adversely impact the environment.

### BACKGROUND

The two main additive choices used in automotive antifreezes mixes are Ethylene Glycol (EG) and Propylene Glycol (PG) mixed typically 50:50 by volume with water. Even though EG is highly toxic to humans and animals it is often used instead of PG due to its significantly lower viscosity and marginally better thermal conductivity. Potassium formate mixed with water is a significant improvement over EG and PG coolants in terms of viscosity and thermal conductivity, but it has a lower specific heat and is at least 15% more dense.

Besides Ga—In—Sn, a eutectic alloy, which has a freezing point too high for automotive and many industrial applications and a limited specific heat, all the coolants in the chart below lag fresh water in terms of the optimal viscosity, thermal conductivity, and specific heat. Therefore, using thermal hysteresis agents (THAs) to enable a coolant to contain as much water content as possible while still having a freezing point of −10° C. to −40° C. or colder would be a major improvement over the prior art.

THAs are already used in ice cream to maintain a small crystal size and the texture creamy. Many THAs are also ice structuring proteins (ISP) and are designed consistent with the biological nucleation crystal inhibitors found in fish. One way the ice cream industry accomplishes this is from the fermentation of genetically modified food grade yeast (Saccharomyces cervisiae) in sealed containers.

THAs, antifreeze proteins (AFPs), and ISPs have not been utilized in the enhancement of antifreeze coolants. To this point, they have been used to help form smaller crystals in ice creams, but the novel concept to reduce the percentage of additives required in coolants is new and meaningful. Reducing, or in some cases eliminating, the need for existing additives will greatly increase the thermal performance and flowability, reduce environmental impacts, and lower the cost of coolants used for automotive, aerospace, and industrial heat transfer and cooling systems. Some examples of glycol-based coolant blends are seen below in Table 1.

TABLE 1
Examples of Glycol-Based Coolant Blends:

| | | Protection Against | *Protection Against |
|---|---|---|---|
| % Antifreeze | % Water | Freezing | Boil-Over |
| 30 | 70 | −17° C. | 121° C. |
| 40 | 60 | −23° C. | 126° C. |
| 50 | 50 | −37° C. | 129° C. |
| 60 | 40 | −52° C. | 132° C. |
| 70 | 30 | −64° C. | 136° C. |

*With (15 psi) radiator cap in good condition

As shown below, Table 2 provides a comparison of various materials, including water, detailing the viscosity, thermal conductivity, specific heat and density of each material.

TABLE 2
Raw Material Comparison:

| | | Thermal | | |
|---|---|---|---|---|
| | Viscosity | Conductivity | Specific Heat | Density |
| Fluid | kg · m⁻¹ · s⁻¹ | W · m⁻¹ · K⁻¹ | J · mkg⁻¹ · K⁻¹ | kg · m⁻³ |
| Ethylene Glycol | 0.0162 | 0.258 | 2360 | 1097 |
| Glycerine | 0.950 | 0.285 | 2430 | 1259 |
| Propylene glycol | 0.042 | 0.147 | 2500 | 965.3 |
| Water, Fresh | 0.00089 | 0.609 | 4190 | 1000 |

Table 3, as shown below, compares the coolant characteristics of various materials.

TABLE 3
Commercial Coolants Comparison:

| | Freezing | Flash | | Thermal | Specific | |
|---|---|---|---|---|---|---|
| Coolant | Pt. | Pt. | Viscosity | Conductivity | Heat | Density |
| Chemistry | (° C.) | (° C.) | kg · m⁻¹ · s⁻¹ | W · m⁻¹ · K⁻¹ | J · mkg⁻¹ · K⁻¹ | kg · m⁻³ |
| Aromatic (DEB) | <−80 | 57 | 0.001 | 0.14 | 1700 | 860 |
| Silicate-ester | <−50 | >175 | 0.009 | 0.132 | 1750 | 900 |
| (Coolanol 25R) | | | | | | |
| Aliphatic (PAO) | <−50 | >175 | 0.009 | 0.137 | 2150 | 770 |
| Silicone | <−110 | 46 | 0.0014 | 0.11 | 1600 | 850 |
| (Syltherm XLT) | | | | | | |
| Fluorocarbon | <−100 | None | 0.0011 | 0.06 | 1100 | 1800 |
| (FC-77) | | | | | | |
| EG/Water | −37.8 | None | 0.0038 | 0.37 | 3285 | 1087 |
| 50:50 (v/v) | | | | | | |
| PG/Water | −35 | None | 0.0064 | 0.36 | 3400 | 1062 |
| 50:50 (v/v) | | | | | | |
| Methanol/ | −40 | 29 | 0.002 | 0.4 | 3560 | 935 |
| Water 40:60 | | | | | | |
| (wt./wt.) | | | | | | |
| Ethanol/ | −32 | 27 | 0.003 | 0.38 | 3500 | 927 |
| Water 44:56 | | | | | | |
| (wt./wt.) | | | | | | |
| Potassium | −35 | None | 0.0022 | 0.53 | 3200 | 1250 |
| Formate/ | | | | | | |
| Water 40:60 | | | | | | |
| (wt./wt.) | | | | | | |
| Ga—In—Sn | −10 | None | 0.0022 | 39 | 365 | 6363 |

### SUMMARY

Thermal hysteresis agents (THA), to include AFPs can be used in combination with any style of existing coolant such as ethylene glycol, propylene glycol, glycerin, or potassium formate to reduce the volume of additives required to reduce the freezing point. This lowers the viscosity which helps to improve the flowability and efficiency.

With an estimated 84 million gallons of coolants used globally each year, there are hundreds of millions of pounds of additives needed to reduce the freezing point of antifreeze compositions. The composition disclosed herein can significantly reduce the percentage of additives used while increasing performance due to the higher water content and thermal capabilities.

Reducing the volume of additives required to achieve the desired performance characteristics can lessen the adverse environmental impact of coolants. It can also enable safer additives such as propylene glycol to now outperform their more toxic counterparts like ethylene glycol.

Pure water is an excellent coolant with very low viscosity, great thermal conductivity, high specific heat, and good density. Pure water's main drawback is a high freezing point of 0° C. whereas coolants used in automotive and industrial applications require a freezing point of around −35° C. or lower. The addition of THAs to water can allow the composition to maintain many of its best attributes as a coolant while overcoming its biggest drawback.

THAs create a difference between the melting point and freezing point known as thermal hysteresis (TH). The addition of THAs or AFPs inhibit the thermodynamically favored growth of the ice crystal. Ice growth is kinetically inhibited by the THAs or AFPs covering the water-accessible surfaces of ice.

Thermal hysteresis is easily measured in the lab with a nanolitre osmometer. Organisms differ in their values of thermal hysteresis. The maximum level of thermal hysteresis shown by fish AFP is approximately −3.5° C. However, insect antifreeze proteins are 10-30 times more active than fish proteins. This difference likely reflects the lower temperatures encountered by insects on land.

In contrast, aquatic organisms are exposed only to −1 to −2° C. below freezing. During the extreme winter months, the spruce budworm resists freezing at temperatures approaching minus 30° C. The Alaskan beetle upis ceramboides can survive in a temperature of minus 60° C. by using THAs that are not proteins but are composed of saccharides and fatty acids. Amino acid chromatographic analysis, polyacrylamide gel electrophoresis, UV-Vis spectrophotometry, and NMR spectroscopy indicated that the THAs in upis ceramboides contained little or no protein, yet produce 3.7±0.3° C. of TH at 5 mg/ml, comparable to that of the most active insect antifreeze proteins.

Various objects, features, aspects and advantages of the disclosed subject matter will become more apparent from the following detailed description of preferred embodiments, along with the accompanying drawings in which like numerals represent like components. The contents of this summary section are provided only as a simplified introduction to the disclosure, and are not intended to be used to limit the scope of the appended claims.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

Disclosed herein is an antifreeze coolant/heat transfer composition which uses antifreeze agents to achieve the same level of freeze protection as current commercial coolant/heat transfer fluids. This is accomplished using bio-mimicry of THAs and AFPs found in animals and plants. THAs, AFPs, or ISPs refer to a class of polypeptides produced by certain animals, plants, fungi and bacteria that permit their survival in subzero environments. THAs bind to small ice crystals to inhibit growth and recrystallization of ice that would otherwise be fatal. Unlike glycol antifreeze based products which require 30% to 70% additives, THAs provide protection against freezing at concentrations of just 0.002% to just 0.0033% of other dissolved solutes.

Examples of insects with AFP are the “spruce budworm” which resists freezing to temperatures approaching minus 30° C. and the Alaskan beetle “upis ceramboides” which can survive in a temperature of minus 60° C. by using THA that are not proteins. These antifreeze proteins/agents allow water to supercool without forming any ice crystals since in the absence of nucleators water can exist as a super cooled liquid down to minus 48.3° C. (minus 55° F.) before freezing. The THA disclosed herein can be utilized with water alone to create an effective coolant fluid even at low temperatures. It also can be combined with current antifreeze additives to: 1) reduce the percentage of additives needed to achieve the same freezing point, 2) increase the specific heat and thermal conductivity, and 3) reduce the fluid viscosity to improve flowability and heat transfer.

The disclosed antifreeze and heat transfer composition is preferably comprised of an antifreeze agent and a water solution in which the antifreeze agent is admixed. In operation, upon reduction in temperature below the standard freezing point of water, the antifreeze agent binds to ice crystals to inhibit growth and recrystallization of ice.

An additional freezing point depressant agent selected from the group consisting of glycerine, glycerol, glycerol-1, methanol, ethanol, alcohol, diethylene glycol, triethylene glycol, butylene glycol, ethylene glycol, propylene glycol, dipropylene glycol, 1,2-propylene glycol, 1,3-propylene glycol, potassium formate, potassium acetate, potassium propionate, dipotassium adipinate, alkali metal salts of acetates, alkali metal salts of formates, alkali metal salts of proprionates, alkali metal salts of adipiates, alkali metal salts of Succinates, propanol, butanol, furfurol, furfuryl alcohol, tetrahydrofurfuryl alcohol, ethoxylated furfuryl alcohol, 2-dimethyl ether, 3-dimethyl ether, monoethylether of glycerol, sorbitol, 1,2,6-hexanetriol, trimethylopropane, methoxyethanol, and combinations thereof.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Moreover, the order of the components detailed in the system may be modified without limiting the scope of the disclosure.

We claim:

1. An antifreeze and heat transfer composition, the composition comprising:
a. an antifreeze agent;
b. a water solution in which the antifreeze agent is admixed, wherein upon depression in temperature below the freezing point of the water, the antifreeze agent binds to ice crystals to inhibit growth and recrystallization of ice.

2. The composition of claim 1, wherein the antifreeze agent is an insect antifreeze protein.

3. The composition of claim 1, wherein the antifreeze agent is a fish antifreeze protein.

4. The composition of claim 1, wherein the antifreeze agent is a plant antifreeze protein.

5. The composition of claim 1, wherein the antifreeze agent is a synthetic antifreeze protein.

6. The composition of claim 1, wherein the antifreeze agent is made from genetically modified yeast.

7. The composition of claim 1, wherein the water is deionized water.

8. The composition of claim 1, wherein the water is distilled water.

9. A method of using an antifreeze agent in a water solution that binds to ice crystals to inhibit growth and recrystallization of ice.

10. The method of claim 9, wherein the antifreeze agent is selected from the group consisting of insect antifreeze proteins, fish antifreeze proteins, plant antifreeze proteins and combinations thereof.

11. The method of claim 9, wherein a concentration of insect THA in water of 5 mg/mL depresses the freezing temperature in the range of about 3.4 to 4° C.

12. The method of claim 9, wherein the insect antifreeze agent is a class of polypeptides produced by the spruce budworm (Choristoneura fumiferana).

13. The method of claim 9, wherein the insect antifreeze agent is a class of polypeptides produced by the Alaskan beetle (upis ceramboides).

14. The method of claim 9, wherein the water solution is deionized water.

15. The method of claim 9, wherein the water solution is distilled water.

16. An antifreeze and heat transfer composition, the composition comprising:
a. an antifreeze agent;
b. a water solution in which the antifreeze agent is admixed, wherein upon reduction in temperature below the freezing point of the water, the antifreeze agent binds to ice crystals to inhibit growth and recrystallization of ice; and
c. an additional freezing point depressant component selected from the group consisting of glycerine, glycerol, glycerol-1, methanol, ethanol, alcohol, diethylene glycol, triethylene glycol, butylene glycol, ethylene glycol, propylene glycol, dipropylene glycol, 1,2-propylene glycol, 1,3-propylene glycol, potassium formate, potassium acetate, potassium propionate, dipotassium adipinate, alkali metal salts of acetates, alkali metal salts of formates, alkali metal salts of proprionates, alkali metal salts of adipiates, alkali metal salts of Succinates, propanol, butanol, furfurol, furfuryl alcohol, tetrahydrofurfuryl alcohol, ethoxylated furfuryl alcohol, 2-dimethyl ether, 3-dimethyl ether, monoethylether of glycerol, sorbitol, 1,2,6-hexanetriol, trimethylopropane, methoxyethanol, and combinations thereof.

17. The composition of claim 16, wherein an additional component provides corrosion protection selected from the group consisting of alkali metal salts, alkaline earth metal ion, alkali metal ion, transition metal ion, inorganic phosphate, molybdate ion, nitrate ion, nitrite ion, azole compound, copper and copper alloy corrosion inhibitor, silicates, silicate stabilizer, water-soluble polymer, Sulfurous acid, alkaline compounds, nonferrous metal inhibitors, and combinations thereof.

18. The composition of claim 16, wherein an additional component of fumed nanoparticles increases heat transfer selected from the group consisting of fumed alumina oxide (Al₂O), fumed titanium oxide (TiO), fumed silica oxide (SiO₂), fumed ferric oxide (Fe2O), a mixture of fumed alumina with fumed silica oxide, and combinations thereof.

19. The composition of claim 16 further comprising an additional component to enhance the stability and longevity of the heat transfer composition selected from the group consisting of a phosphonate, a phosphinate, a colorant, a biocide, an antifoam, a surfactant, a dispersant, an anti-scalant, a wetting agent, an additional corrosion inhibitor, and combinations thereof.
